(19) United States
(12) Patent Application Publication
(10) Pub. No.: US 2014/0120917 A1
(43) Pub. Date: May 1, 2014

(54) COMMUNICATION SYSTEM, COMMUNICATION METHOD, BASE STATION , AND MANAGEMENT DEVICE

(71) Applicants: Akio Yoshihara, Osaka-shi (JP); Shinichi Sawada, Osaka-shi (JP); Hirokazu Kobayashi, Osaka-shi (JP); Shigeto Suzuki, Osaka-shi (JP); Shunpei Fuse, Osaka-shi (JP)

(72) Inventors: Akio Yoshihara, Osaka-shi (JP); Shinichi Sawada, Osaka-shi (JP); Hirokazu Kobayashi, Osaka-shi (JP); Shigeto Suzuki, Osaka-shi (JP); Shunpei Fuse, Osaka-shi (JP)

(73) Assignee: SHARP KABUSHIKI KAISHA, Osaka-shi, Osaka (JP)

(21) Appl. No.: 14/128,134

(22) PCT Filed: Jul. 19, 2012
(86) PCT No.: PCT/JP2012/068315

§ 371 Date: Dec. 20, 2013

(30) Foreign Application Priority Data
Jul. 22, 2011 (JP) 2011-160866

(51) Int. Cl. H04W 36/00

(52) U.S. Cl. CPC H04W 36/0033
USPC 455/436

(57) ABSTRACT

A communication system includes a mobile terminal; a management device that manage a position of the mobile terminal; a first base station that creates a first cell area and retains management information for managing a mobile terminal in the first cell area; a gateway, arranged between the first base station and the management device, that retains management information for managing a mobile terminal in the first cell area; and a second base station that creates a second cell area. In a case where the management entity of the mobile terminal is changed from the first base station to the second base station, the first base station updates management information, included in its retaining management information, associated with the relevant mobile terminal, and transmits to the gateway a command to update management information associated with the relevant mobile terminal.

### TECHNICAL FIELD

The present invention relates to a communication system including a gateway connected to a base station, a communication method of the system, a base station directed to the system, and a management device directed to the system.

### BACKGROUND ART

Currently, 3GPP (Third Generation Partnership Project) is now moving towards introducing a Home evolved Node B (hereinafter, also referred to as “HeNB”) in addition to the general evolved Node B (hereinafter, also referred to as “eNB”) in LTE (Long Term Evolution) that is the next generation communication scheme and in LTE-A (LTE-Advanced) that is an advanced version of LTE. The HeNB aims to enlarge the service area and the usage for individuals.

Typically, in a case where a mobile terminal (User Equipment: hereinafter also referred to as “UE”) moves between cell areas created by an eNB or a HeNB, handover occurs. PTDs 1-3 disclose examples of procedures related to such handover.

For the purpose of supporting such handover, two types of interfaces, i.e. S1 interface and X2 interface, are prepared in the LTE scheme or LTE-A scheme. S1 interface is directed to handover using a control channel between each base station and a corresponding gateway. Since the handover using S1 interface requires transfer of control information via the core network, the network load becomes relatively heavy. In contrast, X2 interface is directed to handover based on direct connection between base stations in a pseudo manner without the intervention of data processing at the core network. Therefore, the network load is relatively low.

A base station and a gateway connected to the base station store UE context that is management information for managing mobile terminals present in its own managing cell area. When the aforementioned handover occurs, the base station managing the cell area in which the mobile terminal was present prior to the handover and the gateway connected to that base station must update its retaining UE_context. In other words, the UE context corresponding to the mobile terminal that causes handover must be released.

With regard to such handover, there is a problem that, when handover occurs from a base station connected to a mobility management entity (hereinafter, also referred to as “MME”) via a gateway to a base station connected to the mobility management entity without the intervention of a gateway, the UE_context retained by the relevant gateway is not released (refer to Non Patent Document 1). In view of the foregoing, there is proposed a procedure to update the UE_context retained by the base station of the mobile source and corresponding gateway by means of a command from the mobility management entity.

### CITATION LIST

### Patent Document

PTD 1: WO2010/098035
PTD 2: WO2010/104076
PTD 3: WO2011/004599

### Non Patent Document

NPD 1: Huawei, “Discussion on UE context release in the source HeNB GW for X2 mobility”, 3GPP TSG RAN WG3 #70b meeting R3-110107, Dublin, Ireland, Jan. 17-21, 2011.

### SUMMARY OF INVENTION

### Technical Problem

According to the procedure related to updating the UE_context set forth above, the mobility management entity is notified, following completion of the update of UE_context retained by the source base station and corresponding gateway, that the update has been completed. The mobility management entity must wait for a notification that the UE_context update has been completed. In the case of the above-described method, the mobility management entity must issue a command directed to updating the UE_context. Therefore, there is a possibility that the processing load on the mobility management entity becomes great according to the proposed method.

In view of the foregoing, an object of the present invention is to provide a configuration that can suppress increase of the processing load on the mobility management entity even when handover occurs.

### Solution to Problem

A communication system according to an aspect of the present invention includes a mobile terminal, a management device that manages the position of the mobile terminal, a first base station that creates a first cell area and retains management information for managing a mobile terminal in the first cell area, a gateway, arranged between the first base station and the management device, that retains management information for managing a mobile terminal in the first cell area, and a second base station that creates a second cell area. In a case where the management entity of the mobile terminal is changed from the first base station to the second base station, the first base station updates the management information, included in its own retaining management information, associated with the relevant mobile terminal, and transmits to the gateway a command to update the management information associated with the relevant mobile terminal.

According to another aspect of the present invention, there is provided a communication method of a communication system that includes a management device for managing the position of a mobile terminal, first and second base stations, and a gateway arranged between the first base station and the management device. The communication method includes the steps of: in a case where the mobile terminal moves from a first cell area created by the first base station to a second cell area created by the second base station, the first base station updating management information associated with the relevant mobile terminal, retained by the first base station; and in a case where the management entity of the mobile terminal is changed from the first base station to the second base station, the first base station transmitting to the gateway a command to update management information associated with the relevant mobile terminal.

According to a further aspect of the present invention, there is provided a base station that creates a cell area. The base station is connected to a gateway that retains management information for managing a mobile terminal in the cell area. The gateway is connected to a management device that manages the position of the mobile terminal. The base station includes means for retaining management information to manage a mobile terminal in the cell area; and means for, in a case where the management entity of the mobile terminal is changed from itself to another base station, updating management information, included in the retained management information, associated with the relevant mobile terminal, and transmitting to the gateway a command to update management information associated with the mobile terminal.

According to still another aspect of the present invention, there is provided a management device that manages the position of a mobile terminal. The management device is connected to a first base station via a gateway and directly connected to a second base station that creates a second cell area. The first base station creates a first cell area, and retains management information to manage a mobile terminal in the first cell area. The gateway retains management information to manage the mobile terminal in the first cell area. In a case where the management entity of the mobile terminal is changed from the first base station to the second base station, the first base station updates management information, included in its retaining management information, associated with the relevant mobile terminal. The management device includes means for, in a case where the mobile terminal moves from the first cell area to the second cell area, transmitting to the gateway a command to update the management information associated with the relevant mobile terminal, independent of a notification that the first base station has updated the management information.

### Advantageous Effects of Invention

According to the present invention, increase of the processing load on the mobility management entity can be suppressed even when handover occurs.

### BRIEF DESCRIPTION OF DRAWINGS

FIG. 1 schematically represents a configuration of a communication system envisaged in an embodiment of the present invention.

FIG. 2 is a block diagram representing a schematic configuration of a mobile terminal (UE) according to an embodiment of the present invention.

FIG. 3 is a block diagram representing a schematic configuration of a base station (HeNB) according to an embodiment of the present invention.

FIG. 4 is a block diagram representing a schematic configuration of a gateway according to an embodiment of the present invention.

FIG. 5 is a sequence diagram representing procedures involved in handover shown in FIG. 1 under the current standard.

FIG. 6 schematically represents procedures involved in handover according to a proposed scheme.

FIG. 7 is a sequence diagram representing procedures involved in handover according to the proposed scheme.

FIG. 8 schematically represents procedures involved in handover in a communication system according to a first embodiment of the present invention.

FIG. 9 is a sequence diagram representing procedures involved in handover in a communication system according to the first embodiment of the present invention.

FIG. 10 is a flowchart representing procedures at a source HeNB in a communication system according to the first embodiment of the present invention.

FIG. 11 is a sequence diagram representing procedures involved in handover in a communication system according to a second embodiment of the present invention.

FIG. 12 is a flowchart representing procedures at a source HeNB in the communication system according to the second embodiment of the present invention.

FIG. 13 is a sequence diagram representing procedures involved in handover in a communication system according to a third embodiment of the present invention.

FIG. 14 is a flowchart representing procedures at a source HeNB in a communication system according to the third embodiment of the present invention.

FIG. 15 is a sequence diagram representing procedures involved in handover in a communication system according to a fourth embodiment of the present invention.

FIG. 16 is a flowchart representing procedures in a source HeNB in the communication system according to the fourth embodiment of the present invention.

FIG. 17 is a sequence diagram representing procedures involved in handover in a communication system according to a fifth embodiment of the present invention.

FIG. 18 is a flowchart representing procedures at a source HeNB in a communication system according to the fifth embodiment of the present invention.

FIG. 19 is a sequence diagram representing procedures involved in handover in a communication system according to a sixth embodiment of the present invention.

FIG. 20 is a flowchart representing procedures at a source HeNB in a communication system according to a sixth embodiment of the present invention.

### DESCRIPTION OF EMBODIMENTS

Embodiments of the present invention will be described in detail hereinafter with reference to the drawings. In the drawings, the same or corresponding elements have the same reference characters allotted, and description thereof will not be repeated.

### 1. Overall System Configuration

First, a typical example of a communication system to which an embodiment of the present invention is applied will be described.

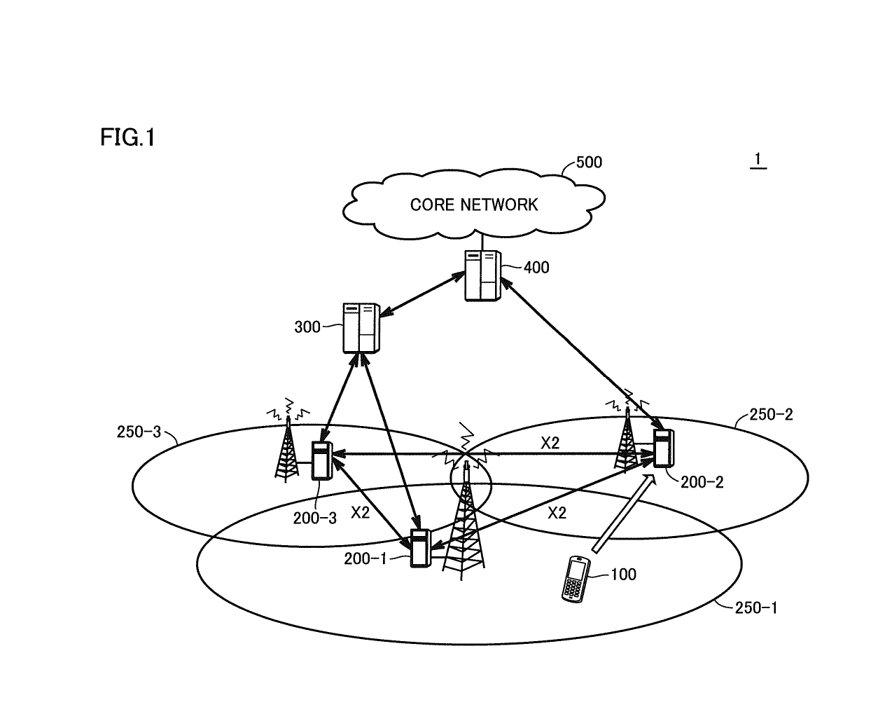

FIG. 1 schematically represents a configuration of a communication system 1 envisaged in an embodiment of the present invention. As a typical example, communication system 1 is assumed to support a communication scheme according to the LTE scheme or LTE-A scheme.

Referring to FIG. 1, communication system 1 includes a mobile terminal (User Equipment: hereinafter also referred to as “UE”) 100, a plurality of home evolved type base stations (Home evolved Node B: hereinafter also referred to as “HeNB”) 200-1 to 200-3, a gateway 300, and a mobility management entity (hereinafter also referred to as “MME”) 400, and a core network 500. Although FIG. 1 represents an exemplified communication system 1 formed of HeNBs, a configuration in which a general evolved type base station (evolved Node B: hereinafter also referred to as “eNB”) is included, alternative to or in addition to HeNBs. The eNB and HeNB may be simply referred to as “base station” generically.

UE 100 is typically a cellular phone, a PDA (Personal Digital Assistant), a data communication terminal, or the like, each transmitting/receiving data to/from another party via any HeNB.

HeNBs 200-1 to 200-3 (hereinafter, also generically referred to as “HeNB 200”) create cell areas 250-1 to 250-3, respectively. Adjacent cell areas are set to overlap each other. Each HeNB 200 retains management information to manage a UE 100 present in a cell area created by itself. This management information is typically UE_context. Typically, UE_context is generated for every UE 100. Each UE_context includes identification information (identifier) to identify a UE 100, an IP (Internet Protocol) address, and the like.

HeNBs 200-1 to 200-3 are assumed to have X2 interface with another HeNB to support handover of UE 100.

Gateway 300 is arranged between HeNB 200 and MME 400 to mediate data communication between HeNBs 200 and/or data communication between HeNB 200 and MME 400. Also, gateway 300 retains management information to manage a UE 100 present in the cell area created by HeNB 200 to which the gateway is connected. This control information is typically UE_context.

Since only HeNB 200-1 and HeNB 200-3 are connected to gateway 300 in communication system 1 of FIG. 1, gateway 300 retains management information substantially identical to the management information retained by HeNB 200-1 and/or HeNB 200-3.

MME 400 is connected to core network 500, and to gateway 300 or HeNB 200. MME 400 manages the position of UE 100. MME 400 implements appropriate routing for data according to the location where UE 100 is present to realize conversation and/or communication between UE 100 and the other party. More specifically, MME 400 provides control such as the setting and release of a session (connection) for packet communication, and/or handover (switching of base station).

By such a function of MME 400, conversation and/or communication is allowed between UEs 100 present in different cell areas. According to the LTE scheme or LTE-A scheme, core network 500 is expected to have all the information set in packets.

In general, UE 100 is carried by a user, moving between cell areas in accordance with the travel of the user. For example, as shown in FIG. 1, in a case where UE 100 present in cell area 250-1 created by HeNB 200-1 moves into cell area 250-2 created by HeNB 200-2, the handover processing according to X2 interface is executed between HeNB 200-1 and HeNB 200-2. Upon completion of this handover processing, the completion is transmitted to MME 400. Then, MME 400 updates the management information of UE 100.

In the description hereinafter, HeNB 200 creating the cell area in which UE 100 prior to handover was present is referred to as “source HeNB”, whereas HeNB 200 creating the cell area of the handover destination of UE 100 is referred to as “target HeNB”. When gateway 300 is connected to HeNB 200 that is the source HeNB in a handover operation, the relevant gateway 300 is also referred to as “source HeNB_GW”.

### 2. Device Configuration

Each of the devices constituting communication system 1 shown in FIG. 1 will be described hereinafter.

(2-1: Configuration of Mobile Terminal (UE))

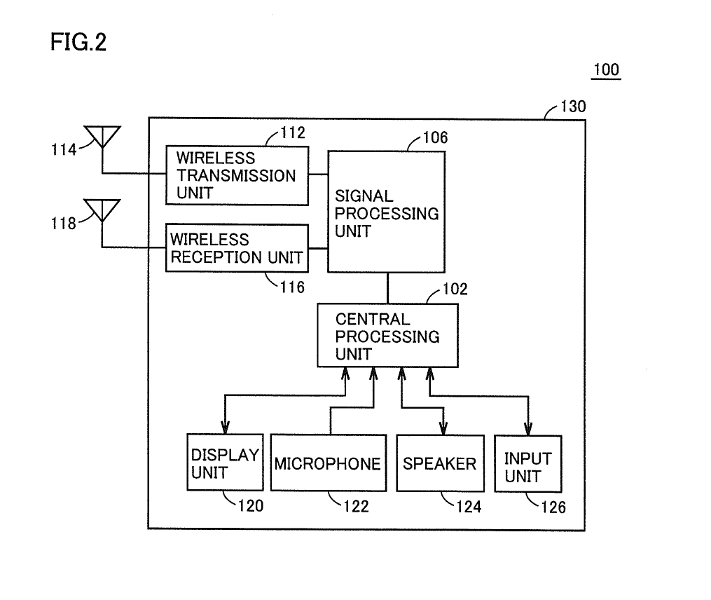

First, the configuration of UE 100 used in communication system 1 according to the present embodiment will be described first. FIG. 2 is a block diagram schematically representing a configuration of mobile terminal (UE) 100 according to an embodiment of the present invention.

Referring to FIG. 2, UE 100 includes a casing 130 in which a transmission antenna 114 for transmitting a radio signal and a reception antenna 118 for receiving a radio signal are provided. Casing 130 includes a central processing unit 102, a signal processing unit 106, a wireless transmission unit 112, and a wireless reception unit 116.

As main constituent elements, central processing unit 102 includes a processor, a non-volatile memory for storing a program executed by the processor, and a volatile memory functioning as a work memory.

Some or all of the functions provided by central processing unit 102 may be mounted on dedicated hardware (for example, integrated circuit). In this case, all of or some of the functions provided by signal processing unit 106, wireless transmission unit 112, and wireless reception unit 116, in addition to the functions provided by central processing unit 102, may be implemented on one chip. Moreover, a SoC (System On a Chip) having components such as the processor, memory, and controller for a peripheral device implemented on one chip may be employed.

As an alternative configuration, all or some of the functions provided by signal processing unit 106, wireless transmission unit 112, and wireless reception unit 116 may be mounted on software. In this case, a functional device (processor) such as a CPU (Central Processing Unit) or DSP (Digital Signal Processor) will execute a set of commands installed in advance.

Signal processing unit 106 handles radio signals transferred with HeNB 200 that manages the cell area where the host device is present. Specifically, signal processing unit 106 outputs to wireless transmission unit 112 information to be transmitted to HeNB 200 according to an internal command provided from central processing unit 102 or the like. Wireless transmission unit 112 applies coding and modulation on the information received from signal processing unit 106 to output the resultant radio signals outside via transmission antenna 114. Moreover, wireless reception unit 116 applies demodulation and decoding to radio signals received via reception antenna 118 to output the result information to signal processing unit 106.

Casing 130 also includes a display unit 120 to display various information, a microphone 122 to obtain the user's voice and the like, a speaker 124 to reproduce the received voice, and an input unit 126 to accept a user manipulation. These members are typically arranged to be exposed at casing 130.

(2-2: Configuration of Base Station (HeNB))

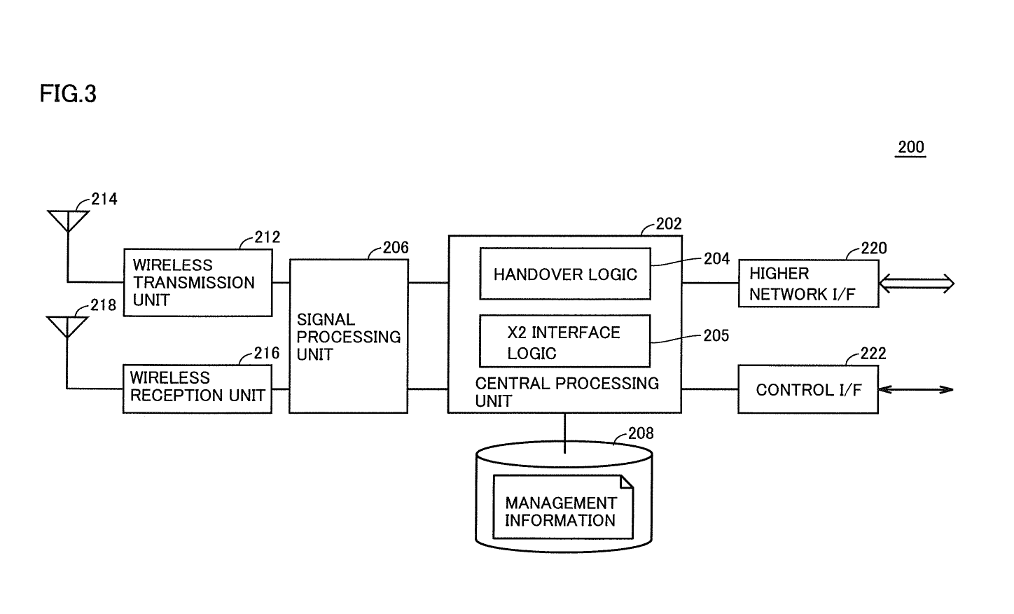

A configuration of HeNB 200 used in communication system 1 according to the present embodiment will be described hereinafter. FIG. 3 is a block diagram representing a schematic configuration of base station (HeNB) 200 according to an embodiment of the present invention.

Referring to FIG. 3, HeNB 200 includes a central processing unit 202, a signal processing unit 206, a storage unit 208, a wireless transmission unit 212, a transmission antenna 214, a wireless reception unit 216, a reception antenna 218, a higher network interface (I/F) 220, and a control interface (I/F) 222.

As main constituent elements, central processing unit 202 includes a processor, a non-volatile memory for storing a program executed by the processor, and a volatile memory functioning as a work memory. Central processing unit 202 further includes a handover logic 204, and an X2 interface logic 205. These logics are typically provided by central processing unit 202 executing a program. For example, a module corresponding to each logic is prestored in the non-volatile memory. Central processing unit 202 reads out and executes these modules to implement functions that will be described afterwards.

Handover logic 204 causes handover with at least one another HeNB 200. The handover is initiated in response to various information transmitted from UE 100. Handover logic 204 causes X2 interface logic 205 to be operated for the handover with HeNB 200. As to handover with HeNB 200 (or eNB) absent of X2 interface, a handover procedure in accordance with S1 interface may be executed using a logic not shown.

X2 interface logic 205 causes a handover operation utilizing a line directly connecting its host station with another HeNB 200.

Handover logic 204 causes management information (UE_context) stored in storage unit 208 to be updated when the handover with a UE 100 is completed.

Some or all of the functions provided by central processing unit 202 may be mounted on dedicated hardware (for example, integrated circuit). In this case, all or some of the functions provided by signal processing unit 206, wireless transmission unit 212, and wireless reception unit 216, in addition to the functions provided by central processing unit 202, may be implemented on one chip. Moreover, a SoC having components such as the processor, memory, and controller for a peripheral device implemented on one chip may be employed.

As an alternative configuration, all or some of the functions provided by signal processing unit 206, wireless transmission unit 212, and wireless reception unit 216 may be implemented as software. In this case, a functional device (processor) such as a CPU or DSP will execute a set of commands installed in advance.

Signal processing unit 206 handles radio signals transferred with UE 100 present in the cell area created by the host station. Specifically, signal processing unit 206 outputs information to be transmitted to UE 100 to wireless transmission unit 212 according to an internal command applied from central processing unit 202 and the like. Wireless transmission unit 212 applies coding and modulation to information received from signal processing unit 206 and outputs the resultant radio signals outside via transmission antenna 214. Moreover, wireless reception unit 216 applies demodulation and decoding to radio signals received via reception antenna 218 and outputs the resultant information to signal processing unit 206.

Higher network interface 210 transfers user data, control information, management information, and the like with gateway 300 or MME 400 by which its host is managed. Similarly, control interface 222 transfers control information with another HeNB 200.

(2-3: Gateway)

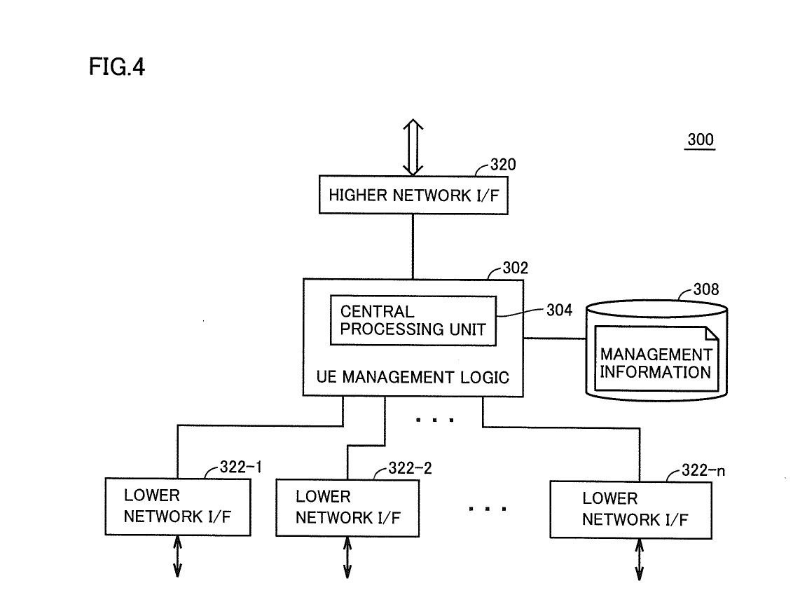

A configuration of gateway 300 used in communication system 1 according to the present embodiment will be described hereinafter. FIG. 4 is a block diagram representing a schematic configuration of gateway 300 according to an embodiment of the present invention.

Referring to FIG. 4, gateway 300 includes a central processing unit 302, a storage unit 308, a higher network interface (I/F) 320, and lower network interfaces (I/F) 322-1, 322-2, . . . , 322-n.

As main constituent elements, central processing unit 302 includes a processor, a non-volatile memory for storing a program executed by the processor, and a volatile memory functioning as a work memory. Central processing unit 302 further includes a UE management logic 304. This logic is typically presented by central processing unit 302 executing a program. For example, a module corresponding to UE management logic 304 is stored in advance in the non-volatile memory. Central processing unit 302 reads out and executes these modules to implement functions that will be described afterwards.

UE management logic 304 detects the mobility and the like of UE 100 between cell areas on the basis of a notification from any HeNB 200 under the control of its host to update management information (UE context) stored in storage unit 308 on the basis of the detected result.

Some or all of the function provided by central processing unit 302 may be mounted on dedicated hardware (for example, integrated circuit). In this case, all or some of the functions provided by higher network interface 320 and lower network interfaces 322-1, 322-2, . . . , 322-n, in addition to the functions provided by central processing unit 202, may be implemented on one chip. Moreover, a SoC having components such as the processor, memory, and controller for a peripheral device implemented on one chip may be employed.

Higher network interface 320 transfers user data, control information, management information and the like with MME4 by which its host is managed. Lower network interfaces 322-1, 322-2, . . . , 322-n transfer user data, control information, management information and the like with HeNB 200 under the control of its host.

(2-4: Mobility Management Entity)

The configuration of MME 400 used in communication system 1 according to the present embodiment is substantially similar to that of gateway 300 shown in FIG. 4. Therefore, detailed description thereof will not be repeated. It is to be noted that a storage unit 308 storing management information does not have to be provided at MME 400.

### 3. Problems Involved in Handover

First, problems involved in handover as shown in FIG. 1 will be described. The example of FIG. 1 corresponds to the case where UE 100 moves from cell area 250-1 created by HeNB 200-1 connected to gateway 300 to cell area 250-2 created by HeNB 200-2. Here, HeNB 200-2 is connected, not to gateway 300, but directly to MME 400.

In the current standard according to the LTE scheme or LTE-A scheme, the method of updating management information (UE_context) retained at the source HeNB_GW that manages the source HeNB is not determined for the case where handover occurs from a HeNB managed by the gateway (source HeNB) to another HeNB not managed by the gateway (target HeNB).

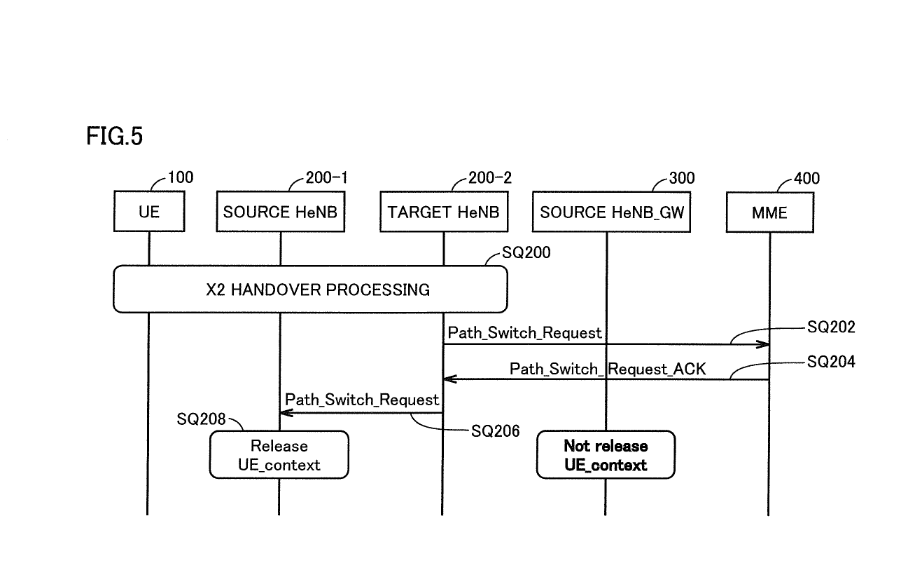

FIG. 5 is a sequence diagram representing procedures involved in the handover shown in FIG. 1 under the current standard. Referring to FIG. 5, the transfer of UE 100 from the source HeNB (HeNB 200-1) to the target HeNB (HeNB 200-2) causes the execution of handover processing between UE 100, the source HeNB, and the target HeNB (in the present example, handover processing according to X2 interface) (sequence SQ200).

Upon completion of the handover processing, the target HeNB transmits to MME 400 a Path_Switch_Request to update the routing information of data towards UE 100 (sequence SQ202). Upon receiving Path_Switch_Request, MME 400 updates its own routing information, and transmits to the target HeNB a Path_Switch_Request_ACK indicating reception of Path_Switch_Request (sequence SQ204).

Upon receiving Path_Switch_Request_ACK, the target HeNB transmits Path_Switch_Request to the source HeNB (sequence SQ206). Upon receiving Path_Switch_Request, the source HeNB releases the management information (UE_context) corresponding to the handed over UE 100, retained at its station (sequence SQ208). Then, the series of processing ends.

As shown in FIG. 5, there is no means for updating the management information (UE_context) retained by the source HeNB_GW in a case where the handover shown in FIG. 1 occurs under the current standard. Therefore, the source HeNB_GW may have to keep storing the management information of a UE 100 that is no longer present in the cell area created by the relevant source HeNB.

### 4. Related Art and Problem Involved with Handover

As described above, the method of updating management information (UE_context) retained at the source HeNB_GW that manages the source HeNB is not determined for the case where handover occurs from a HeNB managed by the gateway (source HeNB) to another HeNB not managed by the gateway (target HeNB) under the current standard involved with the LTE scheme or LTE-A scheme. If the management information (UE_context) of UE 100 retained by the gateway is not released, the gateway will have to constantly manage the information related to UE 100. In the case where a large number of UEs 100 are present, the amount of management information retained by gateway 300 will be so great that the processing load becomes significantly heavy. The resource required for gateway 300 (memory capacity or the like) becomes greater, leading to increase in cost. Therefore, gateway 300 must store only the required management information, and promptly release management information that has become not necessary.

The aforementioned NPTD 1 proposes the following approach. At the time of handover from the source HeNB connected to gateway 300 to the target HeNB not connected to gateway 300, MME 400 manages the processing to update the management information (UE_context) retained by the source HeNB_GW.

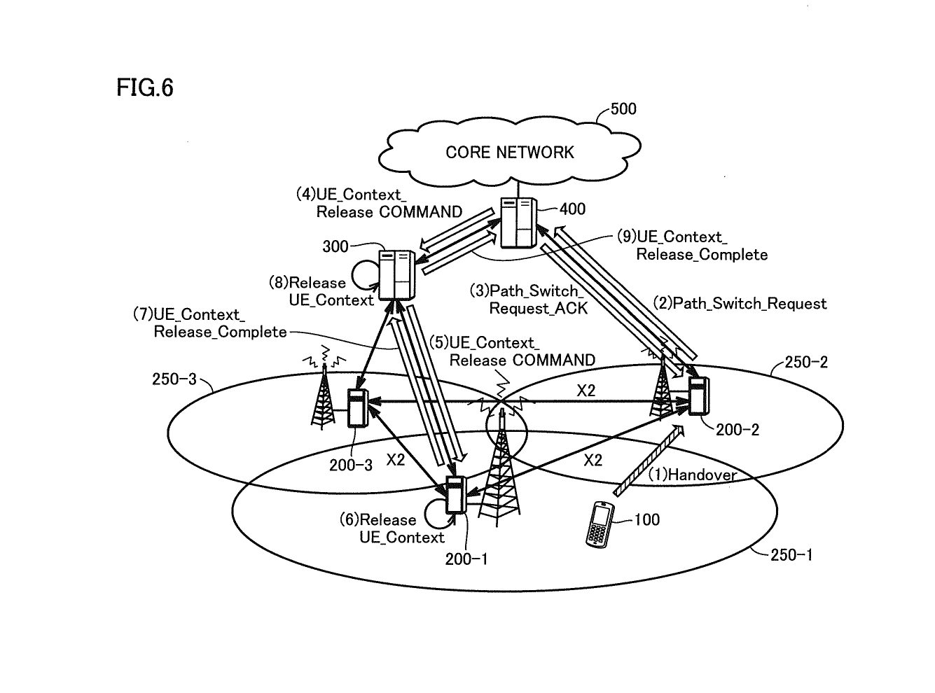

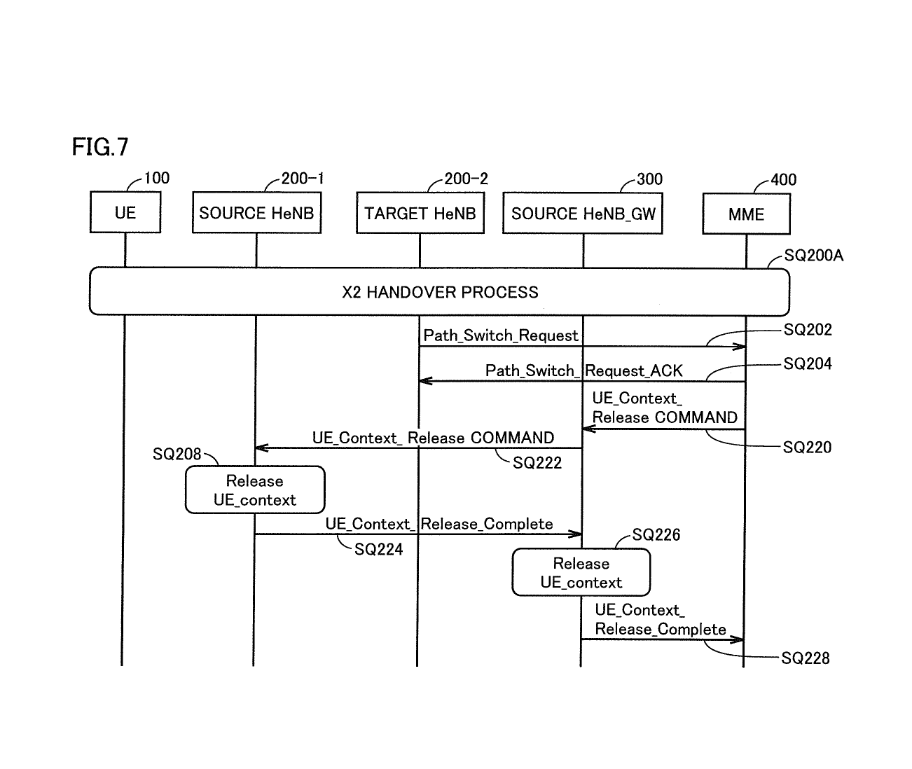

FIG. 6 is a schematic diagram representing the procedures involved with handover according to the proposed approach. FIG. 7 is a sequence diagram representing the procedures involved with handover according to the proposed scheme.

Referring to FIGS. 6 and 7, the transfer of UE 100 from the source HeNB (HeNB 200-1) to the target HeNB (HeNB 200-2) causes execution of handover processing (in the present example, handover processing according to X2 interface) between UE 100, the source HeNB, the target HeNB, and MME 400 (sequence SQ200A)

Upon completion of the handover processing, the target HeNB transmits a Path_Switch_Request to MME 400 (sequence SQ202), similar to that described above. Upon receiving Path_Switch_Request, MME 400 updates its own routing information and transmits a Path_Switch_Request_ACK indicating reception of Path_Switch_Request to the target HeNB (sequence SQ204). Then, MME 400 transmits to the target HeNB a UE_Context_Release command to release the management information (UE_context) retained by the source HeNB (sequence SQ220).

Upon receiving a UE_Context_Release command, the source HeNB releases the management information (UE_context) corresponding to the handed over UE 100, retained at its own station (sequence SQ208). Then, the source HeNB transmits to the source HeNB_GW a UE_Context_Release_Complete indicating that release of the management information corresponding to the handed over UE 100 retained at its own station has been completed (sequence SQ224).

Upon receiving UE_Context_Release_Complete, the source HeNB_GW releases its retaining management information (UE_context) corresponding to the handed over UE 100 (sequence SQ226). Then, the source HeNB_GW transmits to MME 400 a UE_Context_Release_Complete indicating that release of its retaining management information corresponding to the handed over UE 100 has been completed (sequence SQ228).

By such series of procedures, management information that is not necessary is not left at the source HeNB_GW even in the case of handover as shown in FIG. 6.

According to the method disclosed in NPTD 1 set forth above, management information retained by the source HeNB_GW is updated by MME 400 managing the processing. However, this method has problems set forth below.

Since MME 400 detects completion of updating the management information at the source HeNB_GW by UE_Context_Release_Complete from the source HeNB_GW, the process is time consuming. In other words, there is relatively a long period of time before MME 400 identifies that the management information retained at gateway 300 has been updated. Moreover, MME 400 must wait until UE_Context_Release_Complete from the source HeNB_GW is received.

By such reasons, the processing load at MME 400 may become heavy. Furthermore, since many UEs 100 must be managed at MME 400, the procedures as shown in FIGS. 6 and 7 require the resource of MME 400 to be increased. In view of the foregoing, the present embodiment employs the solution set forth below.

### 5. First Embodiment

At a communication system according to the first embodiment, management information (UE_context) retained by the source HeNB_GW is updated by the source HeNB managing the process at the time of handover from the source HeNB to the target HeNB. In other words, in response to the transfer of UE 100 from the cell area created by the source HeNB to the cell area created by the target HeNB, the source HeNB updates management information associated with relevant UE 100 among its retaining management information, and transmits to the gateway by which its host is managed (source HeNB_GW) a command to update the management information associated with the relevant UE 100.

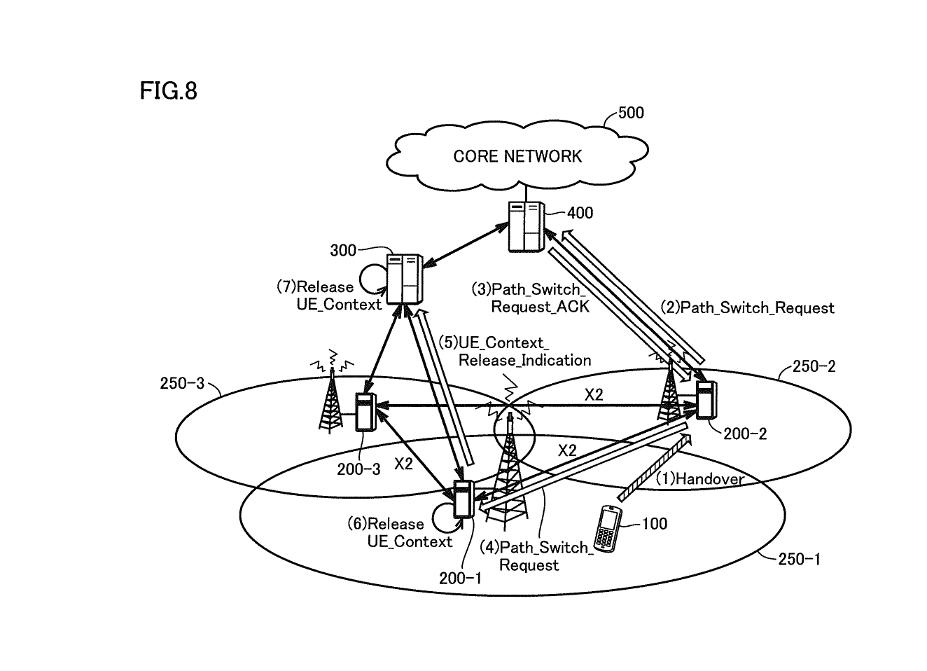

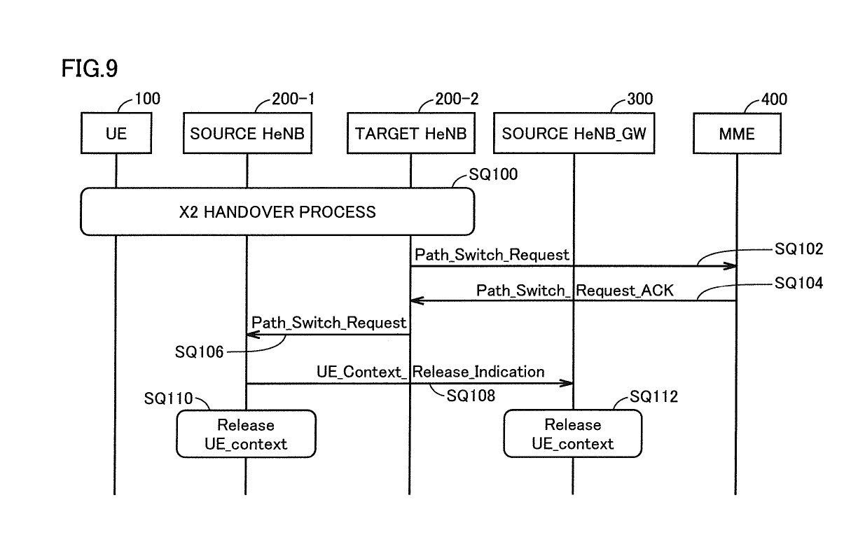

FIG. 8 is a schematic diagram representing procedures involved with handover at the communication system according to the first embodiment of the present invention. FIG. 9 is a sequence diagram representing procedures involved with handover at the communication system according to the first embodiment of the present invention.

The procedures shown in FIGS. 8 and 9 differ from the procedures shown in FIG. 5 in that the source HeNB receives a Path_Switch_Request and that a message to update the management information (UE_context) retained by the source HeNB_GW is sent. In other words, the source HeNB has means for updating management information retained at the source HeNB_GW in the communication system according to the first embodiment.

More specifically referring to FIGS. 8 and 9, the transfer of UE 100 from the source HeNB (HeNB 200-1) to the target HeNB (HeNB 200-2) causes execution of handover processing (in the present example, handover processing according to X2 interface) between UE 100, the source HeNB and the target HeNB (sequence SQ100).

Upon completion of the handover processing, the target HeNB transmits to MME 400 a Path_Switch_Request to update the routing information of data towards UE 100 (sequence SQ102). Upon receiving Path_Switch_Request, MME 400 updates its own routing information, and transmits a Path_Switch_Request_ACK indicating reception of Path_Switch_Request to the target HeNB (sequence SQ104).

Upon receiving Path_Switch_Request_ACK, the target HeNB transmits Path_Switch_Request to the source HeNB (sequence SQ106). Upon receiving Path_Switch_Request, the source HeNB transmits to the source HeNB_GW a UE_Context_Release_Indication that is a message to update the retaining management information (sequence SQ108). Upon receiving UE_Context_Release_Indication, the source HeNB_GW releases its retaining management information (UE_context) corresponding to the handed over UE 100 (sequence SQ112). This management information release processing (update processing) is directed to removing the handed over UE 100 from the interest of management. More specifically, the processing includes the method of deleting UE_context corresponding to the handed over UE 100, the method of adding information (a flag or the like) indicating that UE 100 has moved to an area outside the cell area of the source HeNB, the method of newly storing the contents of management information to manage UE 100, and the like.

Following the transmission of UE_Context_Release_Indication to the source HeNB_GW, the source HeNB releases its retaining management information (UE_context) corresponding to the handed over UE 100 (sequence SQ110). This management information release processing (update processing) is directed to removing the handed over UE 100 from the interest of management, likewise with the aforementioned source HeNB_GW. More specifically, the processing includes the method of deleting UE_context corresponding to the handed over UE 100, the method of adding information (a flag or the like) indicating that UE 100 has moved to an area outside the cell area of the source HeNB, the method of newly storing the contents of management information to manage UE 100, and the like.

Thus, in the first embodiment, subsequent to the source HeNB transmitting to the source HeNB_GW a command to update management information related to UE 100 having its management entity changed from the source HeNB to the target HeNB (typically, UE 100 transferred from the cell area created by the source HeNB to the cell area created by target HeNB), the source HeNB updates management information related to relevant UE 100 included in its retaining management information.

Next, the processing at the source HeNB to implement the procedures shown in FIGS. 8 and 9 will be described hereinafter.

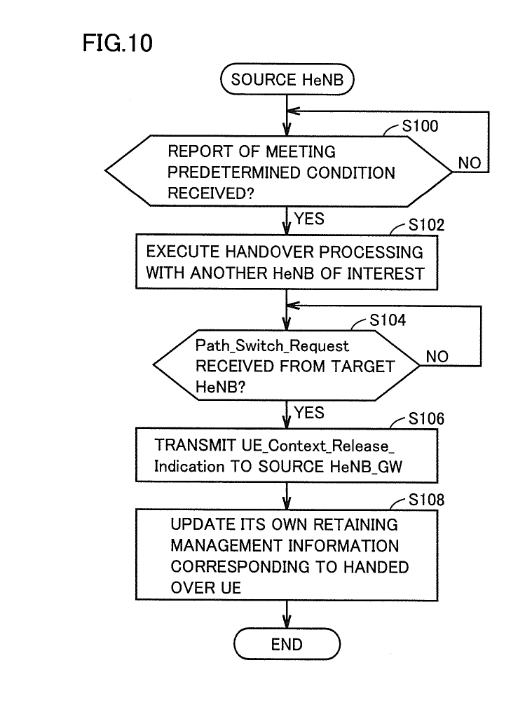

FIG. 10 is a flowchart representing the procedures at the source HeNB in the communication system according to the first embodiment of the present invention. Referring to FIG. 10, HeNB 200 determines whether a report of meeting a predetermined condition has been received from any UE 100 present in its creating cell area (step S100). This predetermined condition is preset by a network (MME 400 or the like). Such a predetermined condition is expected to be “the reception level at another cell area (created by the target HeNB) is higher than the reception level at the present cell area (created by the source HeNB)”. Such a condition is met in a case where UE 100 moves from a cell area created by the source HeNB to a cell area created by the target HeNB. Depending upon the communication environment, there may be the case where UE 100 is present in the cell area created by the source HeNB while a signal from the target HeNB can be received at a higher level. The handover processing is also initiated in such a case. The process of step S100 is directed to determining whether a report that triggers handover processing that will be described afterwards from UE 100 has been notified from UE 100.

In the case where a report of meeting a predetermined condition is not received from any UE 100 (NO at step S100), the process of step S100 is repeated.

In the case where a report of meeting a predetermined condition has been received from any UE 100 (YES at step S100), HeNB 200 determines an event of handover request of UE 100 from which the report originates, and executes handover processing with another HeNB 200 of interest (step S102). Then, HeNB 200 determines whether Path_Switch_Request has been received from the other HeNB 200 (target HeNB) executing the handover processing (step S104). When Path_Switch_Request is not received (NO at step S104), the process of step S104 is repeated.

When Path_Switch_Request is received (YES at step S104), HeNB 200 transmits UE_Context_Release_Indication to the source HeNB_GW (step S106). Then, HeNB 200 updates its retaining management information (UE_context) corresponding to the handed over UE 100 (step S108). Thus, the series of processing ends.

As described above, the reliability of message transmission between the source HeNB and the source HeNB_GW is sufficiently ensured in the first embodiment. Therefore, transmission of UE_Context_Release_Complete to MME 400 is omitted. Accordingly, the waiting for MME 400 to receive UE_Context_Release_Complete, as shown in FIG. 7, is not required. The source HeNB only has to transmit a message for updating the retaining management information towards the source HeNB_GW. Thus, the processing load on both MME 400 and the source HeNB can be alleviated.

Furthermore, since the overall procedure in the first embodiment is simplified, update of management information (UE_context) can be performed rapidly even in the case where many UEs 100 are handed over.

### 6. Second Embodiment

In the communication system according to a second embodiment, management information (UE_context) retained by the source HeNB_GW is updated by the source HeNB managing the processing during the handover from the source HeNB to the target HeNB, likewise with the first embodiment. In other words, in response to transfer of UE 100 from the cell area created by the source HeNB to the cell area created by the target HeNB, the source HeNB updates management information associated with the relevant UE 100 included in its retaining management information, and transmits to the gateway by which it is managed (source HeNB_GW) a command to update the management information associated with relevant UE 100.

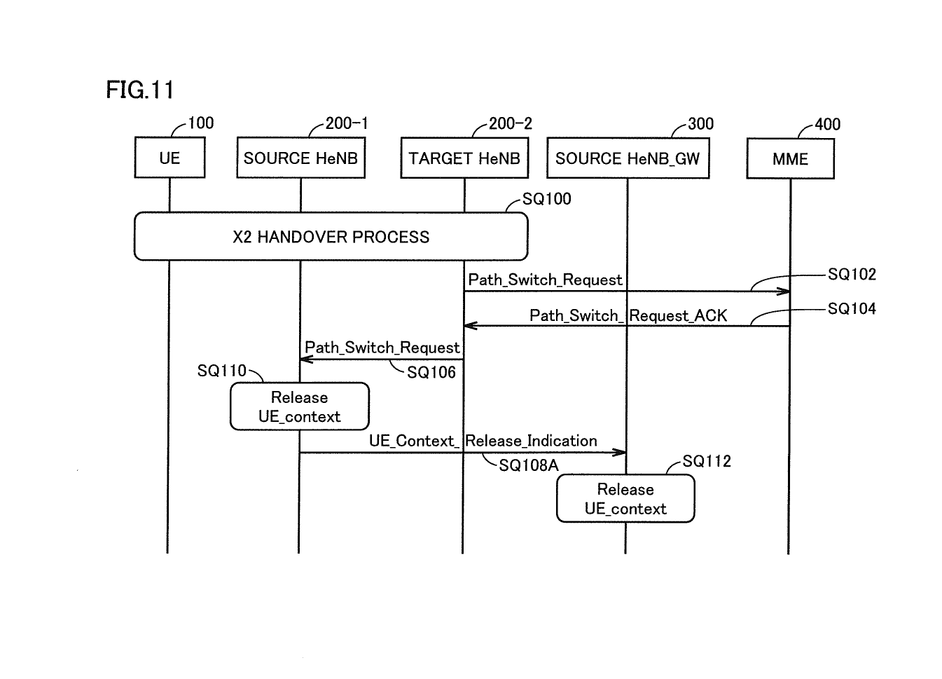

FIG. 11 is a sequence diagram representing procedures involved with handover in the communication system according to the second embodiment of the present invention. The procedures shown in FIG. 11 differ from the procedures shown in FIG. 9 in that the timing of the source HeNB transmitting UE_Context_Release_Indication to the source HeNB_GW differs. Specifically, in the second embodiment, subsequent to updating management information corresponding to UE 100 having its management entity changed from the source HeNB to the target HeNB (typically, UE 100 moving from the cell area created by the source HeNB to the cell area created by the target HeNB), the source HeNB transmits the command to update management information associated with relevant UE 100 to the source HeNB_GW.

More specifically, sequences SQ100-SQ106 of FIG. 11 are similar to sequences SQ100-SQ106 of FIG. 9. Upon receiving Path_Switch_Request, the source HeNB releases its retaining management information (UE_context) corresponding to the handed over UE 100 (sequence SQ110). Then, the source HeNB transmits UE_Context_Release_Indication that is a message directed to updating the retaining management information to the source HeNB_GW (sequence SQ108A). Upon receiving UE_Context_Release_Indication, the source HeNB_GW releases its retaining management information (UE_context) corresponding to the handed over UE 100 (sequence SQ112).

UE_Context_Release_Indication transmitted at sequence SQ108A may have the contents of the management information updated at sequence SQ110 by the source HeNB reflected. In other words, the source HeNB generates UE_Context_Release_Indication on the basis of the contents of updated UE_context. This UE_Context_Release_Indication may include only the modified section among the management information, or may include all the management information, in addition to the section not modified retained by the source HeNB. Thus, although the amount of transmitted information may be increased by transmitting updated management information at the source HeNB to the source HeNB_GW, the management information retained at the source HeNB_GW can be made to match (synchronize) the updated management information of the source HeNB.

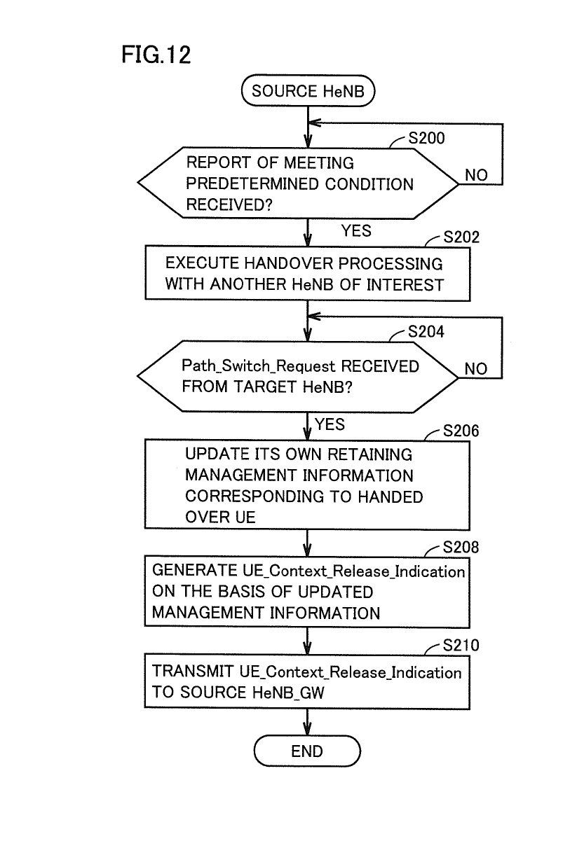

FIG. 12 is a flowchart representing procedures at the source HeNB in the communication system according to the second embodiment of the present invention. Referring to FIG. 12, HeNB 200 determines whether a report of meeting a predetermined condition is received from any UE 100 present in its own creating cell area (step S200). This predetermined condition has been described in the previous first embodiment. Therefore, detailed description thereof will not be repeated here. When a report of meeting a predetermined condition has not been received from any UE 100 (NO at step S200), the process of step S200 is repeated.

When a report of meeting a predetermined condition has been received from any UE 100 (YES at step S200), HeNB 200 determines an event of handover request of UE 100 from which the report originates, and executes handover processing with another HeNB 200 of interest (step S202). Then, HeNB 200 determines whether Path_Switch_Request has been received from the other HeNB 200 (target HeNB) executing the handover processing (step S204). When Path_Switch_Request is not received (NO at step S204), the process of step S204 is repeated.

When Path_Switch_Request is received (YES at step S204), HeNB 200 updates its retaining management information (UE_context) corresponding to the handed over UE 100 (step S206). Then, HeNB 200 generates UE_Context_Release_Indication on the basis of the updated management information (step S208), and transmits the generated UE_Context_Release_Indication to the source HeNB_GW (step S210). Thus, the series of processing ends.

The second embodiment provides the functional advantage set forth below in addition to the advantage likewise with the first embodiment set forth above. Since the source HeNB generates and transmits to the source HeNB_GW a UE_Context_Release_Indication on the basis of the management information (UE_context) updated at its own station, the management information can be made to synchronize between the source HeNB and the source HeNB_GW.

From the standpoint of the source HeNB_GW, completion of updating management information at the HeNB under its control is ensured when UE_Context_Release_Indication is received. Therefore, the source HeNB_GW can update management information without having to take into account the state of the HeNB. Thus, any processing that requires the state of the HeNB to be taken into account can be omitted at the source HeNB_GW.

### 7. Third Embodiment

At the communication system according to a third embodiment, management information (UE_context) retained by the source HeNB_GW is updated by the source HeNB managing the processing at the time of handover from the source HeNB to the target HeNB, likewise with the first embodiment. Specifically, in response to the transfer of UE 100 from the cell area created by the source HeNB to the cell area created by the target HeNB, the source HeNB updates the management information associated with the relevant UE 100 included in its retaining management information, and transmits a command to update management information associated with relevant UE 100 to the gateway by which it is managed (the source HeNB_GW).

In the third embodiment, the source HeNB updates its own management information in response to a notification of completing updating of management information from the source HeNB_GW. Specifically, in response to a notification from the source HeNB_GW that the management information associated with UE 100 having its management entity changed from the source HeNB to the target HeNB (typically, UE 100 moving from the cell area created by the source HeNB to the cell area created by the target HeNB) has been updated, the source HeNB updates management information associated with relevant UE 100 from its retaining management information.

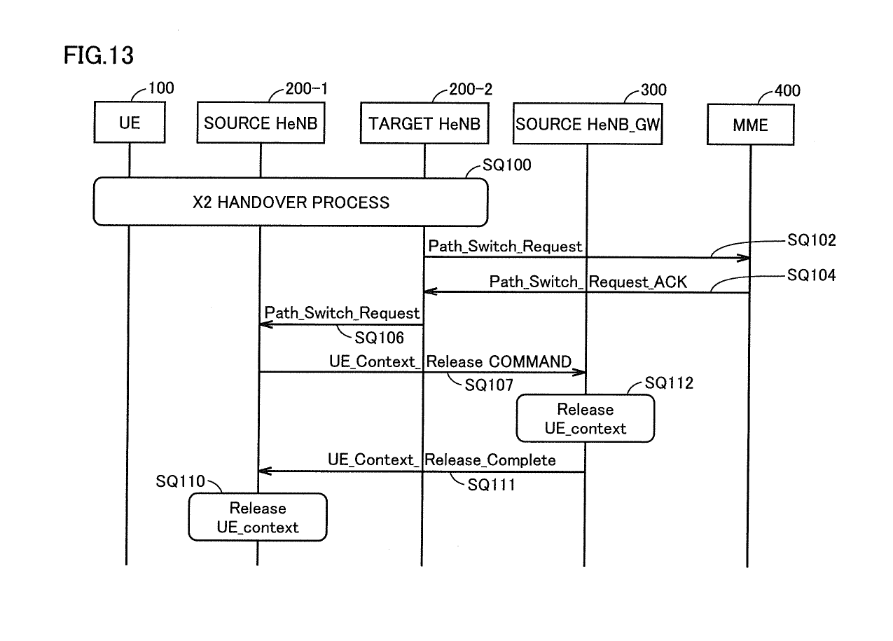

FIG. 13 is a sequence diagram representing procedures involved with handover at the communication system according to the third embodiment of the present invention. Sequences SQ100-SQ106 of FIG. 13 are similar to sequences SQ100-SQ106 of FIG. 9. Upon receiving Path_Switch_Request, the source HeNB transmits to the source HeNB_GW a UE_Context_Release command that is a command to update the retaining management information (sequence SQ107). UE_Context_Release command may include a command code directed to updating management information and a command code directed to notifying update of management information.

Upon receiving a UE_Context_Release command, the source HeNB_GW updates its retaining management information (UE_context) corresponding to the handed over UE 100 according to the received command (sequence SQ112). Then, the source HeNB_GW transmits to the source HeNB a UE_Context_Release_Complete indicating that update of its retaining management information corresponding to the handed over UE 100 has been completed (sequence SQ111).

Upon receiving UE_Context_Release_Complete, the source HeNB releases its retaining management information (UE_context) corresponding to the handed over UE 100 (sequence SQ110). Thus, the series of processing ends.

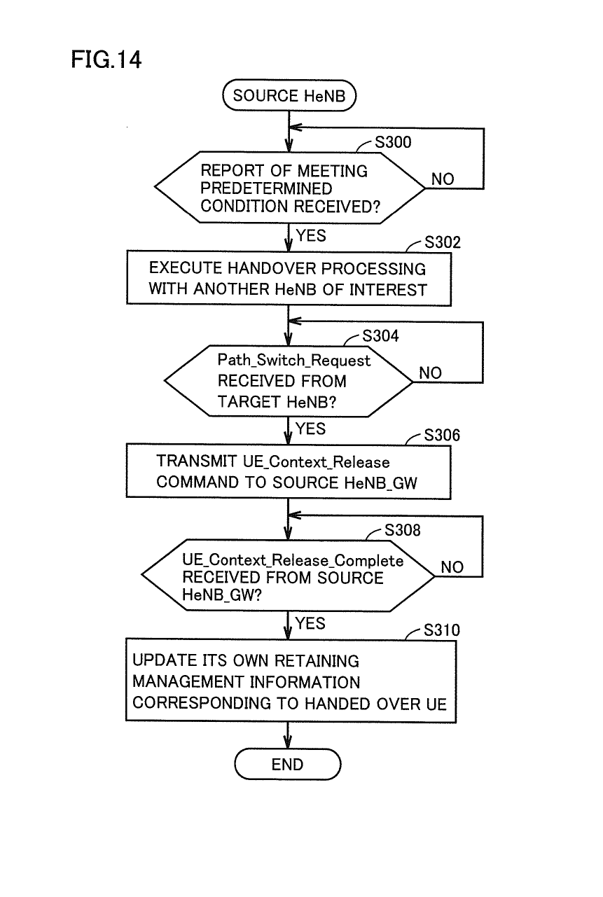

FIG. 14 is a flowchart representing procedures at the source HeNB in the communication system according to the third embodiment of the present invention. Referring to FIG. 14, HeNB 200 determines whether a report of meeting a predetermined condition is received from any UE 100 present in its created cell area (step S300). This predetermined condition has been described in the previous first embodiment. Therefore, detailed description thereof will not be repeated here. When a report of meeting a predetermined condition has not been received from any UE 100 (NO at step S300), the process of step S300 is repeated.

When a report of meeting a predetermined condition has been received from any UE 100 (YES at step S300), HeNB 200 determines an event of handover request of UE 100 from which the report originates, and executes handover processing with another HeNB 200 of interest (step S302). Then, HeNB 200 determines whether Path_Switch_Request has been received from the other HeNB 200 (target HeNB) executing the handover processing (step S304). When Path_Switch_Request is not received (NO at step S304), the process of step S304 is repeated.

When Path_Switch_Request is received (YES at step S304), HeNB 200 transmits a UE_Context_Release command to the source HeNB_GW (step S306). Then, HeNB 200 determines whether UE_Context_Release_Complete is received or not from the source HeNB_GW (step S308). When UE_Context_Release_Complete is not received (NO at step S308), the process of step S308 is repeated.

When UE_Context_Release_Complete is received (YES at step S308), HeNB 200 updates its retaining management information (UE_context) corresponding to the handed over UE 100 (step S310). Thus, the series of processing ends.

According to the third embodiment, the source HeNB updates its own management information in response to completion of update of the management information at the source HeNB_GW. Therefore, the management information can be made to synchronize between the source HeNB and the source HeNB_GW. From the standpoint of the source HeNB, the source HeNB can update its management information under the state where update of the management information at the source of HeNB_GW is ensured. Moreover, from the standpoint of the source HeNB_GW, the source HeNB_GW can update its management information without having to take into account the state of HeNB. Thus, any processing that requires the state of the HeNB to be taken into account can be omitted at the source HeNB_GW.

### 8. Fourth Embodiment

In the communication system according to a fourth embodiment, management information (UE_context) retained by the source HeNB_GW is updated by the source HeNB managing the processing during the handover from the source HeNB to the target HeNB, likewise with the first embodiment. In other words, in response to transfer of UE 100 from the cell area created by the source HeNB to the cell area created by the target HeNB, the source HeNB updates management information associated with the relevant UE 100 included in its retaining management information, and transmits to the gateway by which it is managed (source HeNB_GW) a command to update the management information associated with relevant UE 100.

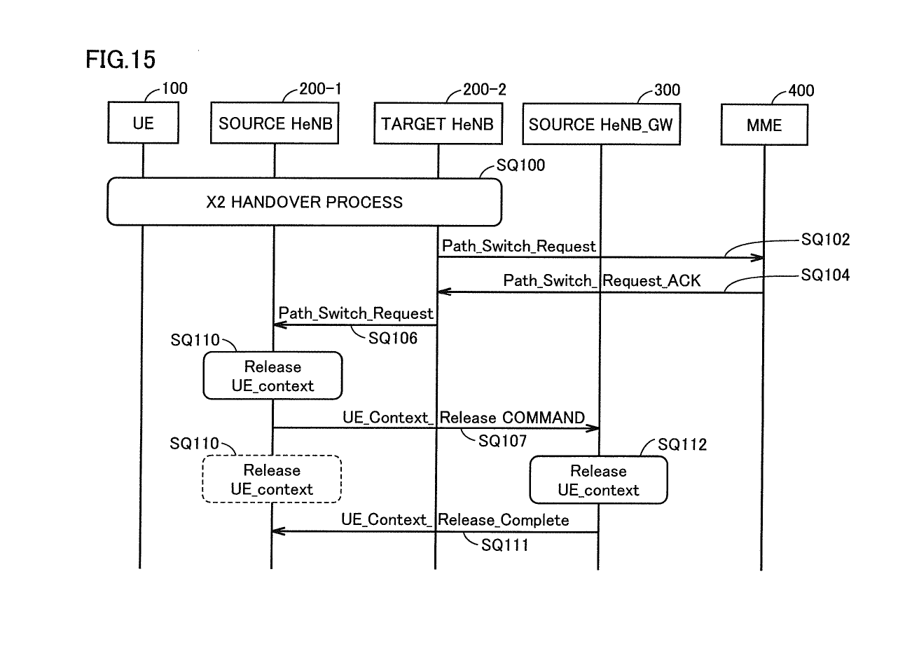

FIG. 15 is a sequence diagram representing procedures involved in handover at the communication system according to the fourth embodiment of the present invention. The procedures shown in FIG. 15 differ in the timing of the source HeNB transmitting a UE_Context_Release command to the source HeNB_GW, as compared to the procedures according to the third embodiment shown in FIG. 13. Specifically, in the fourth embodiment, subsequent to transmitting to the source HeNB_GW a command to update management information associated with UE 100 having its management entity changed from the source HeNB to the target HeNB (typically, UE 100 transferring from the cell area created by the source HeNB to the cell area created by the target HeNB), the source HeNB waits for a notification that management information has been updated from the source HeNB_GW.

Specifically, sequences SQ100-SQ106 of FIG. 15 are similar to sequences SQ100-SQ106 of FIG. 13. Upon receiving Path_Switch_Request, the source HeNB releases its retaining management information (UE_context) corresponding to the handed over UE 100 (sequence SQ110). Then, the source HeNB transmits to the source HeNB_GW a UE_Context_Release command that is a command to update the retaining management information (sequence SQ107). Upon receiving a UE_Context_Release command, the source HeNB_GW releases the management information (UE_context) corresponding to the handed over UE 100, retained at its station (sequence SQ112). Then, the source HeNB_GW transmits to the source HeNB UE_Context_Release_Complete indicating that update of its retaining management information corresponding to the handed over UE 100 is completed (sequence SQ111). Thus, the series of processing ends.

UE_Context_Release command transmitted at sequence SQ107 may have the contents of the management information updated at sequence SQ110 by the source HeNB reflected. In other words, the source HeNB generates UE_Context_Release command on the basis of the contents of updated UE_context. This UE_Context_Release command may include only the modified section among the management information, or may include all the management information, in addition to the section not modified, retained by the source HeNB. Thus, although the amount of transmitted information may be increased by transmitting updated management information at the source HeNB to the source HeNB_GW, the management information retained at the source HeNB_GW can be made to match (synchronize) the updated management information of the source HeNB.

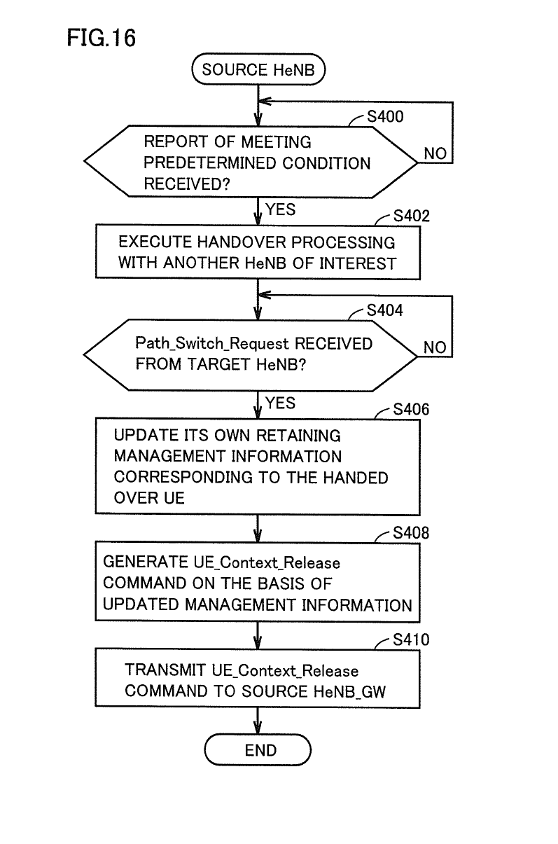

FIG. 16 is a flowchart representing procedures at the source HeNB in the communication system according to the fourth embodiment of the present invention. Referring to FIG. 16, HeNB 200 determines whether a report of meeting a predetermined condition is received from any UE 100 present in its own creating cell area (step S400). This predetermined condition has been described in the previous first embodiment. Therefore, detailed description thereof will not be repeated here. When a report of meeting a predetermined condition has not been received from any UE 100 (NO at step S400), the process of step S400 is repeated.

When a report of meeting a predetermined condition has been received from any UE 100 (YES at step S400), HeNB 200 determines an event of handover request of UE 100 from which the report originates, and executes handover processing with another HeNB 200 of interest (step S402). Then, HeNB 200 determines whether Path_Switch_Request has been received from the other HeNB 200 (target HeNB) executing the handover processing (step S404). When Path_Switch_Request is not received (NO at step S404), the process of step S404 is repeated.

When Path_Switch_Request is received (YES at step S404), HeNB 200 updates its retaining management information (UE_context) corresponding to the handed over UE 100 (step S406). Then, HeNB 200 generates a UE_Context_Release command on the basis of the updated management information (step S408), and transmits the generated UE_Context_Release command to the source HeNB_GW (step S410). Thus, the series of processing ends.

The fourth embodiment provides the functional effect set forth below in addition to the functional advantage similar to that of the second embodiment described above. Namely, the source HeNB can confirm that the management information retained at the source HeNB_GW has been updated. Therefore, in the event of communication error or the like and the update of the management information at the source HeNB_GW was not executed appropriately, the error can be corrected.

### 9. Modification of Fourth Embodiment

In the fourth embodiment shown in FIG. 15, subsequent to the update of its retaining management information (UE_context) corresponding to the handed over UE 100, the source HeNB transmits to the source HeNB_GW a UE_Context_Release command that is a command to update the management information. Alternatively, subsequent to the transmission of a UE_Context_Release command that is a command to update the management information to the source HeNB_GW, the source HeNB may update its retaining management information corresponding to the handed over UE 100 (refer to the block indicated by a broken line in FIG. 15).

Detailed processing according to a modification of the fourth embodiment can be readily understood in view of the fourth embodiment set forth above. Therefore, no further description thereof is provided.

The modification of the fourth embodiment provides the functional advantage set forth above in addition to the functional advantage similar to that of the fourth embodiment set forth above. Namely, the time required to perform the series of processing can be shortened since the source HeNB and the source HeNB_GW update the management information concurrently.

### 10. Fifth Embodiment

In the communication system according to a fifth embodiment, management information (UE_context) retained by the source HeNB_GW is updated by the source HeNB managing the processing during the handover from the source HeNB to the target HeNB, likewise with the first embodiment. In other words, in response to transfer of UE 100 from the cell area created by the source HeNB to the cell area created by the target HeNB, the source HeNB updates management information associated with the relevant UE 100 included in its retaining management information, and transmits to the gateway by which it is managed (source HeNB_GW) a command to update the management information associated with relevant UE 100.

In the fifth embodiment, in response to completion of the management information update at the source HeNB_GW, MME 400 is notified of the completion, on the basis of the third embodiment, the fourth embodiment, and the modification of the fourth embodiment set forth above. In other words, in response to a notification from the source HeNB_GW that the management information associated with UE 100 having its management entity changed from the source HeNB to the target HeNB (typically, UE 100 moving from the cell area created by the source HeNB to the cell area created by the target HeNB) has been updated, the source HeNB transmits to MME 400 completion of management information update in the fifth embodiment.

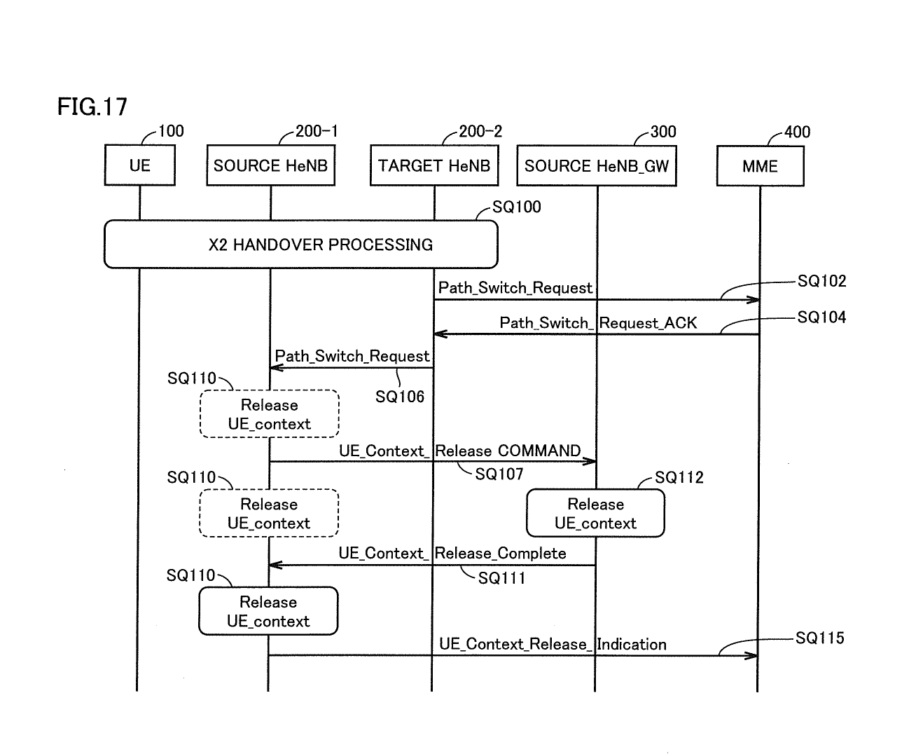

FIG. 17 is a sequence diagram representing procedures involved in handover in the communication system according to the fifth embodiment of the present invention. The procedures shown in FIG. 17 differ in the process subsequent to update (sequence SQ110) of its retaining management information (UE_context) corresponding to the handed over UE 100 by the source HeNB, as compared to the procedures shown in FIG. 13.

Specifically, after releasing its retaining management information (UE_context) corresponding to the handed over UE 100 (sequence SQ110), the source HeNB transmits a UE_Context_Release_Indication to MME 400 (sequence SQ115) on the basis of UE_Context_Release_Complete from the source HeNB_GW. In other words, the source HeNB responds to a notification from the source HeNB_GW to notify MME 400 about completion of management information update at the source HeNB and source HeNB_GW.

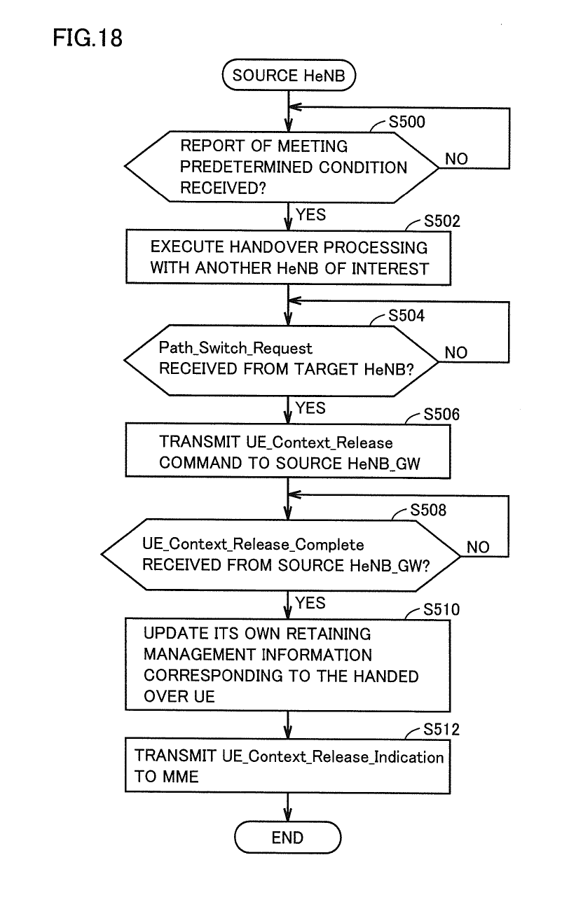

FIG. 18 is a flowchart representing the procedures at the source HeNB in the communication system according to the fifth embodiment of the present invention. Referring to FIG. 18, HeNB 200 determines whether a report of meeting a predetermined condition is received from any UE 100 present in its own creating cell area (step S500). This predetermined condition has been described in the previous first embodiment. Therefore, detailed description thereof will not be repeated here. When a report of meeting a predetermined condition has not been received from any UE 100 (NO at step S500), the process of step S500 is repeated.

When a report of meeting a predetermined condition has been received from any UE 100 (YES at step S500), HeNB 200 determines an event of handover request of UE 100 from which the report originates, and executes handover processing with another HeNB 200 of interest (step S502). Then, HeNB 200 determines whether Path_Switch_Request has been received from the other HeNB 200 (target HeNB) executing the handover processing (step S504). When Path_Switch_Request is not received (NO at step S504), the process of step S504 is repeated.

When Path_Switch_Request is received (YES at step S504), HeNB 200 transmits a UE_Context_Release command to the source HeNB_GW (step S506). Then, HeNB 200 determines whether UE_Context_Release_Complete has been received from the source HeNB_GW (step S508). When UE_Context_Release_Complete has not been received (NO at step S508), the process of step S508 is repeated.

When UE_Context_Release_Complete has been received (YES at step S508), HeNB 200 updates its retaining management information (UE_context) corresponding to the handed over UE 100 (step S510). Then, HeNB 200 transmits UE_Context_Release_Indication to MME 400 (sequence SQ512). Thus, the series of processing ends.

In the communication system of the fifth embodiment, the source HeNB may be made to update its retaining management information corresponding to the handed over UE 100 before or after transmitting a UE_Context_Release command to the source HeNB_GW (sequence SQ107), likewise with the communication system according to the fourth embodiment or the modification of the fourth embodiment shown in FIG. 15.

The fifth embodiment provides the functional advantage set forth below in addition to the functional advantage likewise with the third embodiment, the fourth embodiment, or the modification of the fourth embodiment set forth above. From the standpoint of MME 400, update of management information at the source HeNB and source HeNB_GW can be detected explicitly. Therefore, the management by MME 400 as well as the integrity between the source HeNB and the source HeNB_GW can be maintained.

### 11. Sixth Embodiment

The previous first to fifth embodiments correspond to the example of the source HeNB managing the processing to update management information retained by the source HeNB_GW. The sixth embodiment set forth below corresponds to the case where MME 400 notifies the trigger to update management information retained by the source HeNB_GW.

When handover occurs from the source HeNB to the target HeNB in the communication system of the sixth embodiment, MME 400 notifies about the information for updating the management information (UE_context) retained by the source HeNB_GW. Meanwhile, management information (UE_context) retained by the source HeNB is updated according to the conventional procedures. Specifically, in response to the transfer of UE 100 from the cell area created by the source HeNB to the cell area created by the target HeNB, MME 400 transmits a command to update management information associated with UE 100 to the gateway managing the source HeNB (source HeNB_GW), independent of the notification that the source HeNB has updated the management information.

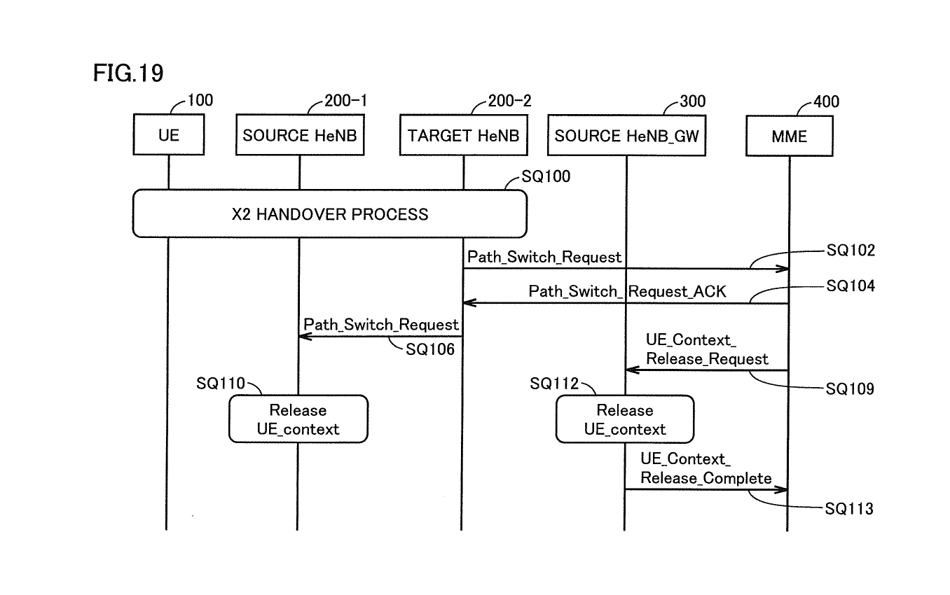

FIG. 19 is a sequence diagram representing procedures involved with handover at the communication system according to a sixth embodiment of the present invention.

The procedures shown in FIG. 19 differ from the procedures shown in FIG. 5 in that, upon receiving Path_Switch_Request, MME 400 transmits a message directed to updating the management information (UE_context) retained by the source HeNB_GW. In other words, in the communication system according to the sixth embodiment, MME 400 has means for updating management information retained by the source HeNB_GW.

More specifically referring to FIG. 19, the transfer of UE 100 from the source HeNB (HeNB 200-1) to the target HeNB (HeNB 200-2) causes execution of handover processing (in the present example, handover processing according to X2 interface) between UE 100, the source HeNB and the target HeNB (sequence SQ100).

Upon completion of the handover processing, the target HeNB transmits to MME 400 a Path_Switch_Request to update the routing information of data towards UE 100 (sequence SQ102). Upon receiving Path_Switch_Request, MME 400 updates its own routing information, and transmits a Path_Switch_Request_ACK indicating reception of Path_Switch_Request to the target HeNB (sequence SQ104).

Upon receiving Path_Switch_Request_ACK, the target HeNB transmits Path_Switch_Request to the source HeNB (sequence SQ106). Upon receiving Path_Switch_Request, the source HeNB releases its retaining management information (UE_context) corresponding to the handed over UE 100 (sequence SQ110).

Following transmission of Path_Switch_Request_ACK set forth above, MME 400 transmits to the source HeNB_GW a UE_Context_Release_Request to update the management information (UE_context) retained by the source HeNB_GW (sequence SQ109). This UE_Context_Release_Request includes information to identify UE 100 moving outside the cell area created by the source HeNB connected to the source HeNB_GW.

Upon receiving UE_Context_Release_Request, the source HeNB_GW releases its retaining management information (UE_context) corresponding to the handed over UE 100 (sequence SQ112). The source HeNB_GW transmits to MME 400 UE_Context_Release_Complete indicating that update of its retaining management information corresponding to the handed over UE 100 has been completed (sequence SQ113). The transmission of a response message indicating update (release) of management information by the source HeNB_GW to MME 400 may be omitted.

The processing at the source HeNB to implement the procedures as shown in FIG. 19 will be described hereinafter.

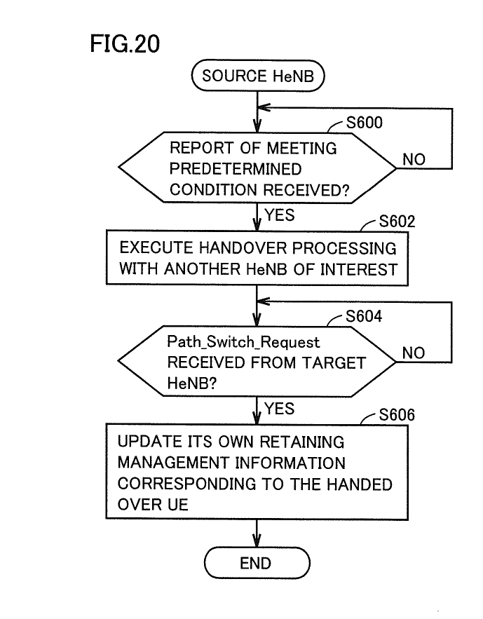

FIG. 20 is a flowchart representing the procedures at the source HeNB in the communication system according to the sixth embodiment of the present invention. Referring to FIG. 20, HeNB 200 determines whether a report of meeting a predetermined condition is received from any UE 100 present in its own creating cell area (step S600). This predetermined condition has been described in the previous first embodiment. Therefore, detailed description thereof will not be repeated here. When a report of meeting a predetermined condition has not been received from any UE 100 (NO at step S600), the process of step S600 is repeated.

When a report of meeting a predetermined condition has been received from any UE 100 (YES at step S600), HeNB 200 determines an event of handover request of UE 100 from which the report originates, and executes handover processing with another HeNB 200 of interest (step S602). Then, HeNB 200 determines whether Path_Switch_Request has been received from the other HeNB 200 (target HeNB) executing the handover processing (step S604). When Path_Switch_Request is not received (NO at step S604), the process of step S604 is repeated.

When Path_Switch_Request is received (YES at step S604), HeNB 200 updates its retaining management information (UE_context) corresponding to the handed over UE 100 (step S606). Thus, the series of processing ends.

In the sixth embodiment, the handover operation of UE 100 is under the management of the target HeNB by the procedures involved with Path_Switch_Request. Therefore, even when MME 400 executes procedures independent of the above-described procedures, update of management information by the source HeNB_GW can be ensured. Accordingly, MME 400 can reliably update management information (UE_context) retained by the source HeNB_GW.

The procedures according to the sixth embodiment facilitates implementation since the modification to the handover procedure in a conventional LTE macrocell is small.

### 12. Advantage

When a mobile terminal (UE) is handed over to a base station (HeNB) during communication with another HeNB, in a system of the LTE or LTE-A scheme, the present embodiment allows update of management information related to the relevant UE, retained by the gateway (source HeNB_GW) managing the previous HeNB (source HeNB).

By employing any of the methods of the first to sixth embodiments set forth above, the time required for processing can be shortened and the processing load on the management device (MME) can be distributed and reduced even in the case where handover is performed for many UEs.

Namely, according to the present embodiment, the load on MME can be reduced by the source HeNB sharing a part of the load. Therefore, even in the case where a plurality of UEs are handed over together at one time, the efficiency as a whole can be improved by the distributed processing through the source HeNB corresponding to each UE.

According to the present embodiment, management information retained at the management device (MME) can be updated more rapidly. Moreover, the management information retained by the source HeNB_GW can also be updated more rapidly.

According to the present embodiment, the source HeNB detects a UE being handed over before the management device (MME) does. Therefore, the series of procedures can be completed faster.

Although the above embodiments have been described based on a handover operation between home evolved Node B (HeNBs), the base station that is of interest in the present invention is not limited to a home evolved Node B (HeNB), and can be applied to a handover operation related to a general evolved Node B (eNB) or another type of base station creating a macrocell.

### 13. Other Aspects

A communication method according to an aspect of the present invention includes several preferable embodiments set forth below.

Preferably, subsequent to transmission to the gateway of a command to update management information associated with a mobile terminal having its management entity changed from the first base station to the second base station, the first base station updates management information associated with the relevant mobile terminal included in its retaining management information.

Preferably, subsequent to update of management information associated with a mobile terminal having the management entity changed from the first base station to the second base station among its retaining management information, the first base station transmits a command to update management information associated with the relevant mobile terminal to the gateway.

Preferably, in response to a notification from the gateway that management information associated with a mobile terminal having the management entity changed from the first base station to the second base station has been updated, the first base station updates management information associated with the relevant mobile terminal included in its retaining management information.

Preferably, subsequent to transmission of a command to update management information associated with a mobile terminal having its management entity changed from the first base station to the second base station, the first base station waits for a notification that management information has been updated from the gateway.

Further preferably, in response to a notification from the gateway that management information associated with a mobile terminal having the management entity changed from the first base station to the second base station has been updated, the first base station transmits the update of management information to the management device.

A communication system according to another aspect of the present invention includes a mobile terminal, a management device managing the position of the mobile terminal, a first base station creating a first cell area and retaining management information for managing a mobile terminal in the first cell area, a gateway arranged between the first base station and the management device, and retaining management information to manage a mobile terminal in the first cell area, and a second base station creating a second cell area. When the management entity of the mobile terminal changes from the first base station to the second base station, the first station updates management information associated with the relevant mobile terminal from its retaining management information. When the mobile terminal moves from the first cell area to the second cell area, the management device transmits to the gateway a command to update management information associated with the relevant mobile terminal, independent of a notification that the first base station has updated the management information.

According to still another aspect of the present invention, there is provided a communication method of a communication system including a management device managing the position of a mobile terminal, first and second base stations, and a gateway arranged between the first base station and the management device. The communication method includes the steps of: in a case where a mobile terminal moves from a first cell area created by the first base station to a second cell area created by the second base station, the first base station updating management information associated with the relevant mobile terminal, retained by the first base station; and in a case where the management entity of the mobile terminal is changed from the first base station to the second base station, the management device transmitting to the gateway a command to update management information associated with the relevant mobile terminal.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

1 communication system; 100 mobile terminal (UE); 102, 202, 302 central processing unit; 106, 206 signal processing unit; 112, 212 wireless transmission unit; 114, 214 transmission antenna; 116, 216 wireless reception unit; 118, 218 reception antenna; 120 display unit; 122 microphone; 124 speaker; 126 input unit; 130 casing; 200 home evolved Node B (HeNB); 204 handover logic; 205 interface logic; 208, 308 storage unit; 210, 320 higher network interface; 222 control interface; 250 cell area; 300 gateway; 304 management logic; 322-1, 322-2, . . . , 322-n lower network interface; 400 MME; 500 core network.

1. A communication system comprising:
a mobile terminal;
a management device configured to manage a position of the mobile terminal;
a first base station configured to create a first cell area, and to retain management information for managing a mobile terminal in the first cell area;
a gateway, arranged between the first base station and the management device, configured to retain management information for managing a mobile terminal in the first cell area; and
a second base station configured to create a second cell area, wherein
in a case where a management entity of the mobile terminal is changed from the first base station to the second base station, the first base station updates management information, included in its retaining management information, associated with the relevant mobile terminal, and transmits to the gateway a command to update management information associated with the relevant mobile terminal.

2. The communication system according to claim 1, wherein, subsequent to transmitting to the gateway the command to update the management information associated with the relevant mobile terminal of which the management entity is changed from the first base station to the second base station, the first base station updates management information, included in its retaining management information, associated with the relevant mobile terminal.

3. The communication system according to claim 1, wherein, subsequent to updating the management information, included in its retaining management information, associated with the mobile terminal of which the management entity is changed from the first base station to the second base station, the first base station transmits to the gateway the command to update the management information associated with the relevant mobile terminal.

4. The communication system according to claim 1, wherein, in response to a notification from the gateway that the management information associated with the mobile terminal of which the management entity is changed from the first base station to the second base station has been updated, the first base station updates the management information, included in its retaining management information, associated with the relevant mobile terminal.

5. The communication system according to claim 1, wherein, subsequent to transmitting to the gateway the command to update the management information associated with the mobile terminal of which the management entity is changed from the first base station to the second base station, the first base station waits for a notification from the gateway that the management information has been updated.

6. The communication system according to claim 5, wherein, in response to the notification from the gateway that the management information associated with the mobile terminal of which the management entity is changed from the first base station to the second base station has been updated, the first base station transmits update of management information to the management device.

7. (canceled)

8. A base station configured to create a cell area, the base station connected to a gateway configured to retain management information for managing a mobile terminal in the cell area, the gateway connected to a management device configured to manage a position of the mobile terminal, the base station comprising:
means for retaining management information to manage a mobile terminal in the cell area; and
means for, in a case where a management entity of the mobile terminal is changed from itself to another base station, updating management information, included in its retaining management information, associated with a relevant mobile terminal, and transmitting to the gateway a command to update management information associated with the relevant mobile terminal.

9. A management device configured to manage a position of a mobile terminal, the management device being connected to a first base station via a gateway and directly connected to a second base station configured to create a second cell area,
the first base station configured to create a first cell area and to retain management information to manage a mobile terminal in the first cell area,
the gateway configured to retain management information to manage a mobile terminal in the first cell area,
the first base station configured to update management information associated with a relevant mobile terminal included in its retaining management information, in a case where a management entity of the mobile terminal is changed from the first base station to the second base station,
the management device comprising means for, in a case where the mobile terminal moves from the first cell area to the second cell area, transmitting to the gateway a command to update the management information associated with the relevant mobile terminal, independent of a notification that the first base station has updated management information.
